(19) United States
(12) Patent Application Publication
(10) Pub. No.: US 2026/0173224 A1
(43) Pub. Date: Jun. 18, 2026

(54) INDUCTION COOKWARE FOR PROVIDING POWER INSTRUCTIONS TO AN INDUCTION HOB

(71) Applicant: Ztove APS, Odense S (DK)

(72) Inventor: Peter Aagaard Favrholdt, Odense M (DK)

(21) Appl. No.: 19/126,966

(22) PCT Filed: Nov. 3, 2023
(86) PCT No.: PCT/DK2023/050265

§ 371 Date: May 2, 2025

(30) Foreign Application Priority Data
Nov. 4, 2022 (DK) PA202270535

(51) Int. Cl. H05B 6/06; A47J 36/32

(52) U.S. Cl. CPC H05B 6/062; A47J 36/321; H05B 2213/06

(57) ABSTRACT

Disclosed is an induction cookware comprising a base part for placing on an induction hob, one or more temperature sensors arranged in said base part, a power supply, an input for providing operating instructions, a data processing unit configured to provide power instructions on the basis of operating instructions provided by said input, and a transmitter configured to transmit said power instructions to said induction hob. A method of heating an induction cookware and an induction cooking system are further disclosed.

### FIELD OF THE INVENTION

The present invention relates to an induction cookware configured to transmit power instructions to an induction hob, a method of heating an induction cookware, and an induction cooking system.

### BACKGROUND OF THE INVENTION

Cooking is the art, science and craft of using heat to prepare food items for consumption. The techniques involved in cooking have evolved drastically from ancient times where cooking fires were used to prepare simple meals up to the present day and age where the approach to cooking is influenced by science, e.g., in the form of molecular gastronomy. With these modern approaches to cooking there are increasing technical requirements to the equipment used in the cooking processes as some of these cooking processes are very delicate and require accurate control of the involved cooking temperatures, even accurate within a few degrees Celsius.

Such accurate temperature control may be obtained using cookware comprising a temperature probe capable of measuring a temperature of the cookware. However, there is still room for improvement of such cookware.

### SUMMARY OF THE INVENTION

The inventors have made several improvements relating to intelligent cookware and subsequently made the below-described invention which increases usability of such cookware.

An aspect of the present invention relates to an induction cookware comprising:
a base part for placing on an induction hob;
one or more temperature sensors arranged in said base part;
a power supply;
an input for providing operating instructions;
a data processing unit configured to provide power instructions on the basis of operating instructions provided by said input; and
a transmitter configured to transmit said power instructions to said induction hob.

Thereby is provided an advantageous induction cookware in which the initiative in the control of a cooking process is lying with the induction cookware. Having the control initiative at the induction cookware side of a cooking system is advantageous in that the induction cookware is usable on any type of induction hob capable of receiving and interpreting power instructions transmitted by the induction cookware. Also, the induction hob does not need to have any existing knowledge about the specific cookware being used in order for the cooking process to proceed. As such, the induction hob merely has to obey the power instructions transmitted by the cookware for the cooking process to proceed. Likewise, the induction cookware does not require any existing knowledge about the specific induction hob as long as the power instructions are transmitted to the induction hob. From the perspective of the cookware, it is not a matter of importance which specific induction hob is being used, or which cooking zone thereof is being used, it is only relevant that transmitted power instructions are received and interpreted by the induction hob.

Not only is the control initiative lying at the induction cookware, but the induction cookware also comprises one or more temperature sensors. This is furthermore advantageous in that improved accuracy may be obtained in a cooking process. The temperature sensor ensures that the induction cookware can monitor the temperature of the induction cookware at all times during the cooking process to check how the cooking process is proceeding and check whether power adjustments may be needed. If the induction cookware detects that power adjustments are needed, it is possible for the induction cookware to ensure that such adjustments are made quickly as it has the initiative in the control of the cooking process. An example could be that a user of the induction cookware adds another ingredient to the content in the induction cookware during a cooking process and this leads to a sudden drop in temperature. The cookware can quickly respond to this change in temperature as soon as the temperature drop is detected at a temperature sensor and send a new and updated power instruction to the induction hob specifying that more inductive power is required in order to obey the operating instructions provided by the input. In other words, by the fact that the induction cookware comprises one or more temperature sensors and has the control initiative is achieved a fast-responding cookware capable of accurate control of a cooking process.

A further advantage of the control initiative being at the cookware side of the cooking system, and that the cookware is independent from the induction hob, is that future firmware/software updates may only be needed for the induction cookware. The induction hob, on the other hand, may be a simple general purpose induction hob (capable of receiving power instructions) which may require less frequent updates (if any). Therefore, suppliers of induction cookware according to the present invention may only need to focus on improving the functionality (via firmware and/or software updates) of the induction cookware and not on improving the functionality of the induction hob. This is advantageous in that the suppliers of the induction cookware can improve functionality of the cookware without being technically limited by technical constraints imposed by various induction hobs. And this is advantageous in that new induction cookware may be introduced later (not known at the time of manufacturing of the induction hob) without having to update the firmware in the induction hob.

In the context of the present invention, the term “cookware” is understood as any kind of cooking receptacle or cooking vessel in (or on) which food is placed when being cooked. The term cookware may thus encompass any type of cooking receptacle or cooking vessel including cooking pots such as sauce pots, stock pots and stew pots and cooking pans such as saucepans, saucier pans, sauté pans, frying pans, grill pans and wok pans. Furthermore, within the context of the present invention, the term “cookware” is understood as a kind of cooking receptacle or cooking vessel arranged to be placed on a hob for the purpose of cooking food.

By the term hob may also be understood a cooktop or a stove. A hob may provide heating to cookware placed thereon through different heating mechanisms depending on the type of the hob. A gas hob delivers heating energy through burning of a gas, a ceramic hob delivers heating through heat radiation, and an induction hob delivers heating through induction. Of these types of hobs an induction hob is typically the most precise, reactive, and energy efficient, and for these reasons induction hobs are gaining grounds among consumers of household products but also in professional kitchens.

Thus, the term “induction cookware” is understood as any kind of cooking receptacle, or cooking vessel as indicated above which is at least capable of being heated through induction on an induction hob.

The present induction cookware comprises a base part which is suitable for placing on an induction hob. That is, the base part of the induction cookware is the part of the cookware that is in contact with the induction hob during cooking. The base part of the cookware may comprise one or more material layers configured to be inductively heated by an induction hob. For example, the one or more material layers may comprise a ferromagnetic material layer.

The present induction cookware comprises one or more temperature sensors arranged in the base part of the cookware. By the term “temperature sensor” is understood any kind of sensor which is capable of establishing a measure that is representative of a temperature of the base part of the cookware. The measure may be a direct measure of temperature, or it may be a measure from which a temperature is derivable or deducible from. Examples of temperature sensors include resistive temperature detectors (RTD), thermocouples and thermistors.

The one or more temperature sensors are advantageously arranged in the base part of the cookware. Thereby is ensured a stable arrangement of the sensor protecting the sensor against dislodging from the cookware due to use of the cookware or impacts to the cookware from e.g. dropping of the cookware. Furthermore, arranging the one or more temperature sensors in the base part of the cookware is advantageous in that the base part of the cookware is in close proximity to a cooking surface of the cookware (surface which is in contact with food or liquid present in the cookware). Thereby is ensured that an established measure of temperature may be more representative of actual temperatures of food items present on the cooking surface than if the one or more temperature sensors were arranged in (or on) the cookware at a position further away from the food items present in the cookware.

In the context of the present invention, the term “power supply” is understood as any kind of device capable of storing energy and delivering electric power or harvesting energy and delivering electric power. As an example, the power supply may comprise a battery, such as a replaceable battery or a rechargeable battery, an energy harvesting unit capable of harvesting thermal energy or harvesting energy through induction, or a mains connection. Providing a power source in the induction cookware is advantageous in that the induction cookware may then comprise electronic components including among others a data processing unit, an input and a transmitter.

In the context of the present invention, an “input” is understood as any kind of device capable of either generating or conveying an input to the induction cookware. Such devices include data receivers for receiving data input transmitted wirelessly (or by wire) by an electronic device, and also physical inputs arranged on the induction cookware including buttons such as push buttons and haptic buttons, or switches such as toggle switches, selector switches and joystick switches. In particular the input is capable of generating or conveying an operating instruction to the induction cookware. For example, by pressing on one or more physical inputs arranged on the induction cookware a particular operating instruction may be selected for the induction cookware, or alternatively, the operating instruction may be generated elsewhere, such as on an electronic device, and received through the input (in the form of a receiver).

By an “operating instruction” is understood any kind of digital instruction defining a target cooking condition in the induction cookware. For example, the operating instruction may define a target temperature to be reached by the induction cookware, or alternatively, define a cooking procedure or recipe.

In the context of the present invention, a “data processing unit” is understood as any kind of computer processing arrangement capable of electronic processing of data such as a microprocessor, a microcontroller, a central processing unit (CPU), or a field programmable gate array. The data processing unit is configured to generate power instructions on the basis of operating instructions provided by the input. In other words, the data processing unit ensures that the cooking conditions requested by means of the operating instruction are achieved in the induction cookware through generation of appropriate power instructions.

In the context of the present invention, the term “power instructions” is understood as any kind of electronic request provided by the induction cookware concerned with the heating state of the cookware. The power instruction is preferably implemented in the form of a digital request, however, the power instruction may also be implemented in an analog manner. For example, the power instruction may comprise a request for the induction hob to deliver a certain power (for example 2400 Watts) to the cookware, a certain power density (for example 10 Watts per square centimetre) or the power instruction may simply be a request for the induction hob to deliver more or less power to the cookware.

In the context of the present invention, a “transmitter” is understood as any kind of unit capable of wireless data transmission. The transmitter may facilitate data transmission according to various wireless communication protocols including Bluetooth, such as Bluetooth low energy (BLE), WiFi, cellular communication protocols including 3G, 4G, LTE and 5G, and other wireless communication protocols such as Zigbee and Z-Wave. Alternatively, the transmitter may facilitate data transmission in an analogue way, such as by FM or AM radio. According to a preferred embodiment of the invention, the transmitter is arranged to facilitate digital data transmission.

In an embodiment, said input comprises a data receiver configured to receive operating instructions transmitted by an external electronic device.

The input of the cookware may comprise a data receiver configured to receive operating instructions transmitted by an external electronic device, such as an electronic device selected among a smartphone, a tablet, a smartwatch, a laptop, or any other data processing device or remote control comprising a user interface and being capable of communicating data electronically. The data receiver may also facilitate data communication with a dedicated controller (also comprising a user interface) such as a remote control. The data receiver may facilitate wireless data communication with the external electronic device using any of the wireless communication protocols described above with respect to the transmitter of the induction cookware. Alternatively, the data receiver may facilitate data transmission in an analogue way, such as by FM or AM radio, with the external electronic device.

In an embodiment, said induction cookware does not comprise a user interface.

According to this embodiment, the induction cookware may not comprise a user interface, implying that a user of the cookware cannot provide a desired operating instruction using the cookware alone. By a user interface may be understood buttons, switches, touch displays, or any other kind of human-computer interaction point capable of inputting user selections. Accordingly, for the user to provide an operating instruction, such as to provide a cooking recipe, the user will have to resort to a user interface which is arranged externally to the induction cookware, for example in an external electronic device. Such an external arrangement of a user interface from the induction cookware is advantageous in that the electrical components of the induction cookware, including the data processing unit and the power supply, may be better protected against water, e.g., water boiling in the induction cookware or water used for cleaning the induction cookware, than if the cookware had a user interface as such an interface may introduce additional joints wherethrough water may leak. Accordingly, by not having a user interface arranged on the induction cookware, the reliability of the induction cookware may be improved.

It is important to realize, that even though a user interface is not arranged on the induction cookware and is arranged externally from the induction cookware, the induction cookware still has the responsibility of receiving operating instructions and transmitting power instructions to the induction hob on which it is placed thereby making sure that the power control function remains in the local vicinity of the induction cookware and induction hob.

In an embodiment, said data processing unit implements a power control function.

By a “power control function” may be understood the control logic underpinning the entire cooking process. Naturally, an induction hob comprises power electronics, e.g., a power supply, ensuring that inductive power is generated by an induction coil of the hob, however, in the present context, a power control function may be understood as a functionality which at a higher level determines the amount of power (or power density) that should be delivered to the induction cookware by taking into account at least a provided operating instruction and the condition of the induction cookware, e.g., a temperature of the cookware. The power control function may also or alternatively take into account a compensation model of the cookware. Accordingly, the power control function implements functionality which a typical induction hob of the prior art may not implement, and the power control function may be regarded as the “master” and the induction hob as the “slave” in the power controls.

In an embodiment, said power control function is exclusively implemented by said data processing unit.

Having the power control function exclusively implemented by the data processing unit implies that the power control function is exclusively implemented in the induction cookware and not implemented in other control devices such as external electronic devices. This has the advantage in that the controlling logic of the individual induction cookware always follows along with the cookware irrespective of which induction hob the cookware is placed on and for example irrespective of which external electronic device is used for selecting operating instructions. Not only is the controlling logic following the cookware, but the fact that the controlling logic is implemented in the cookware allows for the cookware to be used with user interfaces which does not have any knowledge of the controlling logic, for example a general-purpose user interface for use with multiple cookware.

In an embodiment, said induction cookware comprises a memory.

The induction cookware may comprise a memory, such as a non-volatile memory, for example a flash memory. Such a memory is advantageous in that it may comprise (or store) operating instructions or other data useful for control of heating of the induction cookware.

In an embodiment, said memory comprises stored data relating to size of said induction cookware.

The memory may comprise data relating to size of the induction cookware, such as one or more size dimensions of the cookware, for example a diameter for a cookware having a circular base part. In general, the size of the induction cookware may also be an area of a cooking surface of the induction cookware. For example, if the cookware is a pan having a diameter of 27 centimetres, the size of the induction cookware may be 573 square centimetres.

Having information of the size of the cookware stored in a memory of the cookware itself is advantageous in that the cookware may use the size data when providing power instructions. There may be a desire in specifying that a certain power density should be provided to the cookware, however, the induction hob may only be capable of supplying a certain power requested. In order for the induction hob to supply the requested power density, the induction hob would have to have knowledge about the size information of the cookware being used. Such information may be cumbersome to handle for the induction hob, in particular when multiple pieces of cookware are used and interchanged over time. By having the size information stored in the cookware, the computer processing unit of the cookware may be able to convert a power density into a power by multiplying the desired power density with the area of the cooking surface. Thereby is achieved that the cookware can be supplied with inductive power according to a specific power density desire without the induction hob needing to have any prior knowledge of the cookware and its size/dimensions.

In an embodiment, said memory comprises a compensation model arranged to estimate an actual temperature of said induction cookware on the basis of one or more temperature measurements provided by said one or more temperature sensors.

In the context of the present invention, a “compensation model” may be understood as a digitally implemented physical and/or mathematical model representative of said induction cookware. The compensation model may relate to physical characteristics of the induction cookware including physical layout and composition of the cookware. The compensation model may further relate to thermal properties of the induction cookware including heat capacity of the cookware and heat losses to the surroundings of the cookware. A key concept of the compensation model is its ability to estimate an actual temperature of the induction cookware. In this sense, an “actual temperature” is understood as the physical temperature of the induction cookware in at least one point of interest of the induction cookware, such as the physical temperature of a cooking surface of the induction cookware.

It is noted that the one or more temperature sensors of the induction cookware is arranged in the base part of the cookware and thereby measurements performed by the one or more temperature sensors do not accurately reflect the actual temperature of a point of interest, e.g., the cooking surface of the cookware. In other words, the temperature of the cookware is measured at a different place than where a cooking process occurs. If this discrepancy between point of measurement and point of interest is not considered it may lead to improper cooking of food items.

This discrepancy between point of measurement and point of interest may advantageously be compensated for by the compensation model which maps measured temperatures (at point of measurement) with actual temperatures (at point of interest) of the cookware. Thus, using such a compensation model is advantageous in that cooking conditions in the induction cookware may more accurately reflect intended cooking conditions. Furthermore, having such a compensation model stored in a memory of the cookware is advantageous in that the induction hob does not need to have any existing knowledge of the compensation model for the specific cookware in order to provide appropriate cooking power. This is particularly advantageous when for example multiple pieces of cookware are used with the same induction hob and the induction hob does not need to have knowledge of compensation models of multitudes of cookware. In that sense the compensation model does not need to be shared with the induction hob, and this is advantageous when for example updates of the compensation model have to be made, as it is easier to update a model on a single device. It is also advantageous since the same compensation model may be used in cooking processes occurring on different induction hobs.

In an embodiment, said compensation model is heating and/or time dependent.

The compensation model may be heating dependent. Thus, in addition to considering measurements of temperature provided by the one or more temperature sensors, the compensation model may further depend on heating applied to the induction cookware by the induction hob. The heating referred to may include the heating requested by the induction cookware using power instructions, or it may include the heating actually supplied by the induction hob which is confirmed by the induction hob. The heating referred to may include a present heating applied to the induction cookware, but it may also include heating that has already been applied to the induction cookware over time, such as previous power setpoints. In that regard, the compensation model may be regarded as a dynamic compensation model.

By being time dependent, the compensation model may take into account latency (time delay) in temperature developments of the induction cookware. Latency refers to the fact that temperature response of the induction cookware is not immediate. For example, as inductive power is supplied to the base part of the induction cookware by an induction hob, the one or more temperature sensors measure an increasing temperature over time, however, if the power is turned off, the one or more temperature sensors may still measure a temperature that is increasing over time. As a matter of fact, the measured temperature may increase more than twenty degrees Celsius once inductive power is turned off, and typically examples of time delays are of the order of 10 seconds. If this latency is not adequately taken into account, it is evident that the cooking surface may become hotter than intended resulting in overcooking of food items. Such overcooking may be critical for some food items such as hollandaise sauce or bearnaise sauce which may become split once a critical temperature has been reached. By taking into account the temperature latency in the cookware, which is predictable by use of the compensation model, it is possible using the compensation model to forecast temperature developments in the cooking process given the present supplied inductive power and possibly change the power supplied to the induction cookware in such a way that the actual temperature of the induction cookware does not substantially overshoot an intended temperature of the cooking process, such as an intended temperature prescribed by the operating instruction. From this it is evident that such a dynamic compensation model enables for advantageous control of the induction cookware, as it may facilitate improved accuracy in the control of a cooking process where temporal developments in temperature can be considered in advance. The dynamic compensation model is further advantageous in that it may speed up a cooking process. For example, by the compensation model reflecting the temperature latency of the induction cookware, it is possible to e.g., apply a lot of inductive power, such as the maximum available power of the induction hob, for as much time as possible in a warm-up-phase before dialling down the supplied power such that the actual temperature in the cookware does not overshoot a target temperature substantially. If the compensation model does not take into account the temperature latency in the cookware, the power may first be dialled down at the time when the intended temperature is reached, however, this would be way too late to do so as the latency in the cookware would result in the temperature crawling up afterwards such that it overshoots the intended temperature. Alternatively, if the compensation model does not take into account the temperature latency the heating would have to be done carefully (and thus slowly) to avoid such overshooting of the temperature.

In an embodiment, said compensation model is arranged to take as input parameters one or more power setpoints.

The compensation model may take as input parameters one or more power set points, such as a present power set point but also power set points that have been used in the cooking process. By power setpoints are understood setpoints relating to power, such as provided by the induction cookware using power instructions, or as provided by the induction hob when acknowledging the induction power actually being delivered. That is, the time delay from applied power to finally reached temperature is taken account of. The heat capacity and/or other physical properties of the induction cookware may then be used to estimate the power that is needed, and this power may then be transmitted to the induction hob by a power instruction.

In an embodiment, said compensation model is arranged to estimate a change of temperature of said induction cookware on the basis of energy supplied to said induction cookware through induction.

The compensation model may be arranged to estimate a change of temperature of the induction cookware, such as a change of temperature of a cooking surface of the induction cookware on the basis of energy supplied to the induction cookware through induction. In other words, the model may simulate the temperature response of the induction cookware as inductive power is applied and thereby forecast how the cookware responds over time to e.g., a change in applied inductive power. Likewise, the compensation model may also predict how much energy should be supplied over a given amount of time, i.e., what inductive power should be supplied to the induction cookware, in order to reach a certain temperature setpoint within a certain time duration as e.g., prescribed by operating instructions. Thereby is provided an advantageous compensation model which may predict temperature developments of the induction cookware given a present inductive power supplied and which may also calculate appropriate power settings in order to reach target cooking conditions prescribed by operating instructions.

In an embodiment, said memory is arranged to store operating instructions provided by said input.

The memory may advantageously store operating instructions. The memory may store predefined operating instructions that are predefined at commission of the induction cookware or which are already generated by a user prior to initiating a cooking process. For example, the user may operate an input (such as buttons, switches, or a touch input) arranged on the induction cookware and select an already defined operating instruction for the data processing unit to operate upon. Furthermore, if the input comprises a data receiver, operating instructions received by the data receiver may be stored in the memory for later use. Thereby, the user of the induction cookware may generate operating instructions on an external electronic device and upload the operating instructions to the induction cookware for immediate use or for later use.

In an embodiment, said operating instructions are cooking recipes.

In an embodiment, said operating instructions defines a temperature setpoint.

A temperature setpoint is a target temperature for the induction cookware to reach during a cooking process. It should be noted that a temperature setpoint does not necessarily specify a temperature to be measured by the one or more temperature sensors but is intended to define an actual temperature of the induction cookware (e.g., of a cooking surface) to be achieved. The operating instructions may define a single temperature to be maintained throughout a cooking process. For example, the operating instruction may specify a temperature of 52 degrees Celsius to be reached in the induction cookware for the purpose of melting chocolate, or it may specify any other temperature technically achievable by the induction cookware in combination with the induction hob. The operating instruction may for example specify that the single temperature setpoint should be maintained for a certain duration of time. Thereby it is possible for the induction cookware to automatically terminate the cooking process. The operating instruction may also prescribe how the warm-up phase leading to the temperature setpoint should proceed. For example, the operating instruction may prescribe a slow warm up phase such that the induction cookware reaches the setpoint slowly, or it may prescribe a fast (or fastest possible) warm up phase where the temperature setpoint is reached as quickly as possible, for example with as much inductive power supply as possible. An operating instruction comprising a temperature setpoint is advantageous in that a user may specify a precise temperature to be achieved by the induction cookware, and thereby the user is able to cook food items requiring a specific cooking temperature.

In an embodiment, said operating instructions defines a power setpoint.

An operating instruction may define a power setpoint or a power density setpoint. Such power setpoints may include specific power setpoints, such as specific powers in units of power, e.g. watts, or in percentage of maximum power, or specific power densities in units of power per area, e.g. watts per square centimetre. Indeed, any unit referring to power or power density may be contemplated.

Defining a power setpoint by an operating instruction is advantageous in that the cooking process may be controlled in terms of power or power density. This is alternative way of controlling a cooking process may be advantageous if for example a user of the cookware is accustomed to cooking using the cookware on an induction hob that is not capable of communicating with the cookware, and the user has knowledge of what power is provided by that induction hob at specific power steps thereof. So, if the user is familiar with the cooking experience provided at e.g., power step 7 of that induction hob, and knows that this step corresponds to e.g., 1200 watts, the user can obtain exactly the same cooking experience on the induction hob according to the present invention, by merely providing as operating instruction a power setpoint of 1200 watts.

In an embodiment, said operating instructions defines a plurality of temperature setpoints.

An operating instruction may define a plurality of temperature setpoints such as a plurality of time-dependent temperature setpoints (i.e., a temperature profile or a cooking recipe). For example, the operating instructions may specify a first temperature setpoint for a first time period followed by a second (and different) temperature setpoint for a subsequent second time period, e.g., 125 degrees Celsius for 3 minutes followed by 150 degrees Celsius for 6 minutes. An operating instruction comprising a plurality of temperature setpoints is advantageous in that it facilitates autonomous control of a cooking process as the induction cookware can follow e.g., a prescribed cooking recipe.

In an embodiment, said operating instructions defines a plurality of power setpoints.

An operating instruction may define a plurality of power setpoints (or power density setpoints) such as a sequence of power setpoints (or a sequence of power density setpoints). These power setpoints may include specific power setpoints, such as specific powers in units of power, e.g., watts, or specific power densities in units of power per area, e.g. watts per square centimetre. Indeed, any unit referring to power or power density may be contemplated. An operating instruction comprising a plurality of power setpoints is advantageous in that it facilitates autonomous control of a cooking process as the induction cookware can follow e.g., a prescribed cooking recipe.

In an embodiment, said memory comprises a default operating instruction.

By “default” may also be understood that the operating instruction is standard for the induction cookware and thereby always available in the induction cookware during e.g., start-up of the cookware. The default cooking instruction may specify a single temperature setpoint which then becomes the default temperature setpoint for the induction cookware during start-up. Such a temperature may also be referred to as a standard temperature. For example, the default operating instruction may specify a single temperature setpoint such as 52 degrees Celsius, which means that every time the induction cookware is placed on an induction hob and the system is started (i.e., turned on), the cookware may have 52 degrees Celsius as a target temperature for the cooking process unless another operating instruction is chosen/provided by the user of the system. The default operating instruction may also specify a plurality of temperature setpoints, such as a plurality of time-dependent temperature setpoints. Thereby is facilitated that the induction cookware by default is set to execute a specific cooking recipe. Having a default operating instruction is advantageous in that a cooking process can be initiated quickly and conveniently as there becomes no need of defining a temperature setpoint (or temperature setpoints) before the cooking process initiates.

In an embodiment, said default operating instruction is exchangeable.

The default operating instruction may be exchangeable, meaning that a user of the cookware can assign default operating instructions according to preference. The exchangeable operating instructions may include exchangeable temperature setpoints (or power setpoints) and exchangeable sequences of temperature setpoints (or sequences of power setpoints). Having an exchangeable default operating instruction is advantageous in that the versatility of the cookware may be improved. The default operating instruction may be exchangeable in that a user of the cookware can save a currently used temperature setpoint (or power setpoint) as a default operating instruction, the user may assign a new temperature setpoint (or power setpoint) as a default operating instruction. Such assignment of either a used setting or a new setting may be made using the cookware, such as by using an input interface of the cookware, or by use of an input interface on the induction hob, or by use of an external electronic device having a suitable input interface.

In an embodiment, said default operating instruction is cooking zone specific.

The default operating instruction may be cooking zone specific, meaning that the operating instruction may automatically apply once the cookware is placed on a given cooking zone of the induction hob. For example the operating instruction being used as a basis for the power instruction may by default be a given temperature when the induction cookware is placed on a first cooking zone of the induction hob. If however, the induction cookware is placed on a second, and different, cooking zone of the induction hob, the default operating instruction being used as a basis for the power instruction may be a cooking recipe. Having a default operating instruction which is cooking zone specific is advantageous in that a cooking process may be initiated faster and this is particularly advantageous in large professional kitchens where repetition of specific cooking processes may often occur.

In an embodiment, said default operating instruction is dependent on any of cooking zone size, cooking zone placement, cooking zone identity, or any combination thereof.

The default operating instruction may be dependent on any of cooking zone size, cooking zone placement, cooking zone identity, or any combination thereof. By a size of a cooking zone may be understood a diameter of a cooking zone. By a cooking zone placement may be understood a physical placement of the cooking zone in relation to the induction hob. By cooking zone identity may be understood an identity or tag designating a specific cooking zone, which identity may be used to distinguish one cooking zone from another cooking zone.

In an embodiment, said default operating instruction is dependent on cookware type and/or cookware identity.

The default operating instruction may be dependent on cookware type and/or cookware identity. By cookware type is for example understood a description of the cookware including cookware model and even cookware size. For example, a cookware model may exist in several sizes, and therefore the correct designation of the cookware type may include cookware size in addition to cookware model. By cookware identity may be understood a cookware id, or any other kind of tag suitable for electronic identification by an induction cooking system, which is unique for a cookware. Thus, if two pieces of similar cookware exist (similar by cookware model and cookware size) they may be distinguishable by their cookware identities.

In an embodiment, said default operating instruction is dependent on a selected power level.

The default operating instruction may be dependent on a selected power level. Selected power level may for example be any of the pre-defined power levels that are selectable using a user interface of the induction hob, such as the 1-9 power levels and the boost power level. Thus, when a user places the induction cookware on a given cooking zone, that cooking zone may have a number of selections to choose from. For example, a user may select power level 1 which becomes a selection of a first default operating instruction, which may be a specific cooking recipe. The user could also have selected power level 5 which defines a fifth default operating instruction in the form of a specific cooking temperature to be maintained by the cookware. These are merely examples of default operating instructions and are not considered limiting on the actual default operating instructions executable by the cookware according to the invention. A skilled person will readily appreciate that any of the power levels (for example power levels 1-9 and boost power) may be configured in any way such that as selection of power level may be coupled to a selection of any default operating instruction to be executed by the induction cookware.

The default operating instruction may be dependent on any parameter selected from the list consisting of cooking zone, cookware type, cookware identity, cooking zone size, cooking zone placement, cooking zone identity, selected power level, or any combination of these parameters.

From the above paragraphs describing the various parameters on which the default operating instruction may depend on, it is immediately evident that advantageous embodiments are provided. By implementing parameters, on which the default operating instruction is dependent on, the versatility, and customizability of the cooking experience may be enhanced. The more parameters on which the default operating instruction is dependent on, the greater number of parameter combinations exist, and thus a greater number of default operating instructions may be configured by the user of the cookware.

In an embodiment, said induction cookware is configured to automatically override an operating instruction upon detection of a lack of compliance in a cooking process defined by said operating instruction.

A cooking process may require some sort of user interaction, for example that a user stirs the content of the induction cookware or shakes the induction cookware to ensure that the content does not stick to the induction cookware and becomes burned. The induction cookware may detect a lack of compliance with such requirements by use of sensors such as the one or more temperature sensors and/or alternatively an accelerometer, or by detection of a lack of confirmation by the user that such an interaction has been performed (a user may confirm that the prescribed interaction has been performed by use of an input interface of the cooking system). If such a lack of compliance is detected, the induction cookware may automatically override the operating instructions in use, such as by automatically transmitting a new power instruction to the induction hob, which power instruction specifies a reduced power/power density, or even specifies that inductive power should be turned off. From the above it is apparent that such an automatic exchange of operating instructions is advantageous in that inappropriate cooking of food content, such as burning of food, may be prevented.

In an embodiment, said power instructions comprises power.

The induction cookware may request a specific power to be supplied by the induction hob using power instructions. The “power” referred to may specify specific amount of power in any suitable units specifying power, such as watts. Equivalently, the power instructions may also comprise requesting energy, such as in units of Joules, to be delivered in a given time window, such as in seconds. For example, one Joule requested over a time window of one second corresponds to one Watt.

In a simple implementation, power may also refer to a percentage of the maximally available power to be supplied by the induction hob. For example, if the cooking zone of the induction hob is rated at a maximum power of 2400 Watts, then a power instruction specifying 100% would correspond to a power instruction specifying 2400 Watts, in the same way that a power instruction specifying 50% would correspond to a power instruction specifying 1200 Watts, and in the same way that 0% would correspond to 0 Watts.

In a yet more simple implementation, the power instruction may specify that either more or less inductive power should be delivered to the induction cookware.

By a power instruction comprising power may also be understood a power instruction including any suitable parameter for controlling and/or modulating the power supplied to the induction cookware by the induction hob.

By the power instructions comprising power is achieved an instruction that is easy for the induction hob to comply with, and a precise control of a cooking process is achieved.

In an alternative embodiment of the invention the power instruction comprises power density. By power density is understood power per area. Such power density may be expressed in multiple ways including any suitable units specifying power per area such as Watts per square centimeter, or Watts per square meter. Alternatively, the power density may also be conveyed by specifying an energy density to be supplied over a time window. For example, one Joule per square centimeter requested over a time window of one second corresponds to one Watt per square centimeter.

In an embodiment, said data processing unit is configured to provide said power instructions on the basis of a temperature measurement provided by said one or more temperature sensors.

The data processing unit may be configured to provide (e.g., generate) power instructions on the basis of a temperature measurement provided by the one or more temperature sensors. Thus, the data processing unit may be communicatively associated with the one or more temperature sensors. Providing the power instruction on the basis of a temperature measurement provided by the one or more temperature sensors is advantageous in that it becomes possible for the data processing unit to take into account measured temperatures of the induction cookware when providing the power instruction. Thereby is achieved an induction cookware capable of controlling heating applied to it in accordance with actual temperature conditions of the induction cookware.

In an embodiment, said power instructions comprise a request for said induction hob to return a parameter associated with heating of said induction cookware.

The power instructions may comprise a request for the induction hob to return a parameter associated with heating of the induction cookware. This parameter may be a digital parameter associated with the heating of the induction cookware performed by the induction hob. Returning this parameter is advantageous in that the induction cookware may get confirmation about the actual heating conditions and adapt a cooking process in response thereto.

An illustrative example of the returning of a parameter is given here. The induction cookware may request the induction hob, by use of a power instruction, that an amount of 2000 Watts are to be supplied to the induction cookware. This may for example be the optimum amount of power for effective execution of a cooking recipe. However, the induction hob only has 1200 Watts in reserve for the cookware since other cookware are also supplied with inductive power and the induction hob has an upper limit to the total power supplied to cookware.

Accordingly, the induction hob may respond to the cookware by confirming that only 1200 Watts are actually being supplied. The cookware may continue to request the 2000 Watts, but as long as this is not possible, it is advantageous that the induction cookware knows what is actually being supplied. Thereby, for example, the compensation model can be updated accordingly to ensure proper cooking according to a cooking recipe irrespective of the fact that the originally requested power is not supplied. For example, knowledge of less power being actually supplied may have the consequence that the cookware adapts and ensures that the lower power is supplied for a longer time to ensure proper cooking.

In an embodiment, said parameter comprises power.

In another embodiment of the invention the parameter comprises power density.

In an embodiment, said induction cookware is configured to provide power instructions on the basis of said parameter.

Providing power instructions on the basis of the parameter returned from the induction hob is advantageous in that the induction cookware may adapt a cooking process to power restrictions imposed by an induction hob. Specifically, this is advantageous for the compensation model of the induction cookware which may be updated. For example, if the induction cookware is undergoing a cooking process where a certain power (or power density) is required for a certain time period, but the induction hob is restricted to supply less power than specified by the cooking process, the induction cookware may adapt and provide a new (updated) power instruction to the induction hob. The updated power instruction may specify a lower power (i.e., the maximum power available for the induction hob to supply) for a longer time duration. For example, the induction cookware may specify that 2000 watts of inductive heating should be applied to it, but, without confirmation from the induction hob, the induction cookware may assume that it is receiving 2000 watts when in fact less power is actually supplied due to e.g., total power limits of the induction hob being reached. Having knowledge of the actual heating applied to the cookware is advantageous in that the induction cookware may adapt to heating restrictions imposed by the induction hob. For example, in the situation where 2000 watts are requested but less power is delivered, the induction cookware may send new updated power instructions in response to the confirmation sent by the induction hob. Such updated power instructions may specify that the maximum available power of the induction hob (less than 2000 watts in this situation) should be supplied over a longer time duration to compensate for the lower power.

In an embodiment, said power instructions are stored in said memory.

The provided, i.e., generated, power instructions may be stored in the memory of the induction cookware. Thereby the generated power instructions may always be available to the induction cookware.

In an embodiment, said data processing unit is configured to provide said power instructions on the basis of size of said induction cookware.

The data processing unit may be configured to provide the power instructions based on size of the cookware, such as based on data relating to size of said induction cookware stored in a memory of said induction cookware. This is advantageous in that the cookware may always be able to provide power instructions irrespective of a desire for a certain power density to be supplied to the cookware. For example, an induction hob may only be able to obey power instructions for a specific amount of power (e.g. a specific amount of watts), but there may be a desire for a specific power density to be supplied to the cookware. By taking into account the size of the cookware, such as an area of a cooking surface of the cookware, the cookware may be able to convert a power density into a power. This is advantageous in that the induction hob may not need to have any prior knowledge of the cookware in order to deliver a power which corresponds to the desired power density.

In an embodiment, said induction cookware is configured to transmit information to an induction hob regarding a size of said induction cookware.

In addition to transmitting power instructions, the transmitter of the induction cookware may further transmit information regarding a size of the induction cookware to the induction hob. This size information may include at least a size of the base part of the induction cookware, such as a diameter or radius of the base part of the induction cookware. Conveying such information to the induction hob is advantageous in that the induction hob may leverage from such information and for example limit the applied inductive power if the induction cookware is positioned on a too large or wrongly dimensioned cooking zone for the cookware. Thereby damage due to cookware may be prevented.

In an embodiment, said input comprises a data receiver.

The input may be a receiver suitable for data communication. Such a receiver may advantageously facilitate data communication with an external electronic device such as an electronic device selected among a smartphone, a tablet, a smartwatch, a laptop, or any other data processing device capable of communicating data. The receiver may also facilitate data communication with a dedicated controller such as a remote control.

Being able to communicate with an external electronic device or controller is advantageous in that additional control and/or functionality may be provided to the induction cookware.

For starters, an external device may be connected to the internet, and thereby the induction cookware may receive data from the internet through the receiver and the internet-enabled external device. Thereby, updates, such as firmware-and/or software updates may be provided to the induction cookware, and furthermore, if the induction cookware comprises a compensation model, the compensation model may be updated/improved.

Furthermore, the receiver may advantageously facilitate two-way communication between the induction cookware and the induction hob. Such two-way communication may facilitate that a response to a power instruction can be received in the induction cookware. Such response may comprise an acknowledgement of receipt of power instruction. When the power instructions comprise instructions for a specific amount of inductive power to be supplied to the induction cookware, the response may include an indication of the actual inductive power being delivered to the induction cookware. It may come to the situation that the induction cookware sends a power instruction to the induction hob which includes a request for receiving e.g., 1200 watts, however, the induction hob is already in use with other pieces of induction cookware and is only able to deliver 900 watts of power. In that case the response may include a message saying that the induction cookware is only receiving 900 watts despite a request for 1200 watts. Such response is advantageous as the induction cookware may be able to adapt to external conditions imposed by the induction hob and adapt the cooking process accordingly to ensure proper cooking. In this example, the induction cookware may learn that only 900 watts are available, not 1200 watts, and therefore, in order to ensure proper cooking according to the operating instructions, the induction cookware may accept the low power and compensate by e.g., ensuring that the 900 watts are applied for a greater time duration than intended with the 1200 watts.

In an embodiment of the invention, said receiver is a wireless receiver. The receiver may be arranged to communicate using similar wireless communication protocols as the transmitter including Bluetooth, such as Bluetooth low energy (BLE), WiFi, cellular communication protocols including 3G, 4G, LTE and 5G, and other wireless communication protocols such as Zigbee and Z-Wave. Alternatively, the receiver may facilitate data transmission in an analogue way, such as by FM or AM radio. According to a preferred embodiment of the invention, the receiver is arranged to facilitate digital data transmission.

In an embodiment, said input comprises an input interface for a user.

The induction cookware may comprise an input interface for a user to input selections, such as selections concerning operating instructions. The input interface may be implemented as one or more buttons (push buttons, haptic buttons, or toggle switches) on the induction cookware, such as one or more buttons arranged on a handle of the induction cookware, or implemented as a touch display arranged on e.g., a handle of the induction cookware. Having an input interface arranged on the induction cookware is advantageous in that it facilitates convenient control of the induction cookware.

In an embodiment, said induction cookware is an induction cooking pan or an induction cooking pot.

In an embodiment, said power supply is any of a battery, an energy harvesting device or a mains connection.

In an embodiment, said induction cookware comprises a plurality of temperature sensors.

The induction cookware may comprise a plurality of temperature sensors distributed at various positions in the cookware. Increasing the number of temperature sensors is advantageous in that greater accuracy can be achieved in a cooking process as the actual conditions of the food items/liquids present in the cookware may better be captured by the cookware when a plurality of sensors are present. The plurality of temperature sensors may be distributed at various positions in the cookware including the base part of the cookware and sides of the cookware. For example, placing an additional temperature sensor on a side of the cookware gives the added benefit that the temperature of a larger quantity of food/liquid can be determined, in particular at portions that are far away from the temperature sensor arranged in the base part of the cookware.

In an embodiment, said induction cookware comprises an accelerometer.

The induction cookware may advantageously comprise an accelerometer. Such a device may for example be used by the induction cookware to detect a user behaviour, such as a lack of compliance with a cooking process. The accelerometer may further be used to detect input gestures, such as tapping on the handle of the induction cookware, moving of the cookware, detect a boiling state in the cookware, e.g., detect boiling in a pot of water, detect movements of the cookware during cooking, for example flipping of a pancake, detect user stirring of food items in the cookware. Lastly, the accelerometer may be used to wake up the induction cookware from a standby power saving mode when not used.

In an embodiment, said induction cookware comprises a display.

The induction cookware may comprise a display. Such a display may be arranged on a handle of the induction cookware. A display is advantageous in that it may convey useful information to the user of the induction cookware including information about the current state of the induction cookware, such as a temperature thereof, and for example also information concerning operating instructions. The display may further facilitate easy selection of e.g., pre-defined operating instructions selectable by the user using e.g., an input interface.

In an embodiment, said data processing unit and said transmitter is arranged within a handle of said induction cookware.

Thereby is ensured that critical components to the functioning of the induction cookware is concealed and protected from the external environment, such as protected from impacts with other cooking equipment including kitchen spoons, knives, spatulas, etc. Further components of the induction cookware, such as power supply and memory may also be arranged within the handle of the induction cookware.

Another aspect of the present invention relates to a method of heating an induction cookware, said method comprising the steps of:
placing an induction cookware on an induction hob, said induction cookware comprising a base part for placing on said induction, one or more temperature sensors arranged in said base part, a power supply, an input for providing operating instructions, a data processing unit, and a transmitter configured to transmit power instructions to said induction hob;
providing operating instructions by said input:
providing, by said data processing unit, a power instruction on the basis of said operating instructions;
transmitting, by said induction cookware, said provided power instruction to said induction hob;
receiving said transmitted power instruction in said induction hob;
providing inductive heating to said induction cookware, by said induction hob, on the basis of said power instruction.

Thereby is provided an advantageous way of operating a cooking process using an induction cookware and an induction hob. The method may facilitate accurate and autonomous cooking according to operating instructions. As the method involves the use of an induction cookware, any advantages described in relation to the induction cookware in the previous provisions also apply for the present method.

In an embodiment, said power instruction is further provided on the basis of one or more temperature measurements provided by said one or more temperature sensors.

Thereby is achieved an advantageous method in which the induction cookware may monitor a cooking process and adapt power instructions in response thereto. This may ensure accurate control of the cooking process.

In an embodiment, said step of providing power instructions comprises providing power instructions on the basis of a compensation model.

Using a compensation model is advantageous in that cooking conditions in the induction cookware may more accurately reflect intended cooking conditions.

In an embodiment, said step of providing operating instruction comprises a user generating said operating instructions.

The user may generate operating instructions using the induction cookware itself, using the induction hob, or by using an external electronic device. For example, when using an external electronic device, the generated operating instructions may be transmitted by the external electronic device and received in the input (e.g., a data receiver) of the induction cookware.

In an embodiment, said input is an input interface and wherein said step of providing operating instructions comprises a user selecting said operating instruction using said input interface.

The user may select the operating instruction using an input interface of the induction cookware. Thereby, the user may select an operating instruction among e.g. a number of pre-defined operating instructions.

In an embodiment, said input of said induction cookware comprises a data receiver configured to receive operating instructions transmitted by an external electronic device, and wherein said step of providing operating instructions by said input comprises:
providing operating instructions, by a user, using an input interface of an external electronic device;
transmitting said operating instruction using a transmitter of said external electronic device; and
receiving said transmitted operating instruction using said data receiver.

By a user providing operating instructions using an input interface of an external electronic device may be understood that the user may select a pre-defined, or generate, an operating instruction using an external electronic device such as a smartphone or a tablet or the like, for example through interaction with a graphical user interface implemented using a touch display of the device. The selected or generated operating instructions are then transmitted to the data receiver of the induction cookware.

In an embodiment, said data processing unit executes a power control function which is arranged in said induction cookware. Preferably, the power control function is arranged exclusively in said induction cookware.

In an embodiment, said operating instructions comprises a recipe.

In an embodiment, said method is carried out using said induction cookware according to any of the previous provisions.

Thereby, any advantages described in relation to the induction cookware according to the previous provisions also apply for the method of heating an induction cookware.

Another aspect of the present invention relates to an induction cooking system comprising:
an induction hob comprising a receiver for receiving power instructions;
an induction cookware comprising:
   a base part for placing on said induction hob;
   one or more temperature sensors arranged in said base part;
   a power supply;
   an input for providing operating instructions;
   a data processing unit configured to providing power instructions on the basis of operating instructions provided by said input; and
   a transmitter configured to transmit said power instructions to said receiver of said induction hob, and
wherein said induction hob is configured to apply inductive power to said induction cookware on the basis of power instructions received by said receiver.

The induction cooking system is advantageous for at least the same reason as the induction cookware and the method of heating an induction cookware.

In the context of the present invention an “induction cooking system” is understood as a system comprising any number of induction hobs and induction cookware capable of being communicatively coupled between the induction hob(s) and the induction cookware(s). For example an induction cooking system according to the present invention may according to one embodiment of the invention comprise a single induction hob and a single induction cookware, however, in other embodiments of the invention the induction cooking system may comprise any number of induction hobs and any number of induction cookware, for example one induction hob and a plurality of pieces of induction cookware such as two pieces of induction cookware, two induction hobs and a single piece of induction cookware, and two induction hobs and a plurality of pieces of induction cookware, such as two pieces of induction cookware, for example 4 pieces of induction cookware.

In an embodiment, said induction cooking system is configured for two-way communication between said induction cookware and said induction hob.

Two-way communication between the induction cookware and the induction hob is advantageous in that power instructions can be transmitted from the induction cookware to the induction hob, the induction hob may return a parameter upon request from the induction cookware, and operating instructions can be exchanged between the induction hob and the induction cookware.

In an embodiment, said induction cooking system is configured to communicate a size of said induction cookware and/or a size of a cooking zone of said induction hob between said induction cookware and said induction hob.

The induction cooking system may be configured to communicate a size of said induction cookware or a size of a cooking zone of said induction hob between said induction cookware and said induction hob. In other words, the induction cookware of the system may communicate a size of it to the induction hob, or the induction hob may communicate a size of the cooking zone, onto which the cookware is placed, to the induction cookware. Such a sharing of size information from one to the other is advantageous in that a coating (e.g., a non-stick coating) of the induction cookware may be protected against excess heating. If there is a mismatch between the size of the induction cookware and a cooking zone of the induction hob, and this is not taken into account in the control of the cooking process, this may in some cases lead to excess heating of the coating of the induction cookware. This is particularly the case when the size of the cooking zone is greater than the size of the cookware, e.g., a diameter of the cooking zone being greater than a diameter of a cooking surface of the cookware. In this case it may be sensible to restrict power output of the induction hob. This may require that the cookware has knowledge of the size of cooking zone on which it is placed, such that the cookware may adjust power instruction accordingly. Alternatively, this may require that the induction hob has knowledge of the induction cookware placed on a cooking zone thereof such that the restriction in power may be imposed by the induction hob.

In an embodiment, said induction cooking system further comprises an external electronic device.

The induction cooking system may comprise an external electronic device, such as a smartphone, a tablet, a laptop, or a smartwatch which is communicatively coupled to the induction cookware and alternatively to both the induction cookware and the induction hob. The external electronic device is external in the sense that it is not directly involved in a cooking process (contrary to the induction cookware and the induction hob) but may however be used for control of the induction cooking system. For example, a user of the induction cooking system may generate or select operating instructions on the external electronic device.

In an embodiment, wherein said input comprises a data receiver, and wherein said external electronic device and said data receiver are configured for transmission of operating instructions from said external electronic device to said data receiver.

In an embodiment, said induction cookware does not comprise a user interface.

In an embodiment, said data processing unit of said induction cookware implements a power control function.

In an embodiment, said power control function is exclusively implemented by said data processing unit.

In an embodiment, said induction cooking system comprises an input interface.

The induction cooking system may comprise an input interface, i.e., a user interface. The input interface may be any kind of electronic input interface which is at least capable of inputting a user selection to the induction cooking system. Suitable input interfaces comprise buttons (haptic buttons, capacitive touch buttons, or push/pressure buttons), rotary knobs, or toggle switches arranged on the induction cookware and/or on the induction hob, but also electronic displays (such as touch displays) arranged on the induction hob and/or on the induction cookware. The input interface may also include an electronic display arranged in an external electronic device such as a smartphone, a tablet, a laptop, or a smartwatch. The input interface may also include an accelerometer and/or gyroscope to facilitate input by using gestures, e.g., tapping a handle of the cookware or tilting the cookware. The input interface is advantageous in that it may facilitate input of a user selection such as a selection of operating instructions.

In an embodiment, said induction cookware is a first induction cookware, and wherein said induction cooking system comprises a second induction cookware.

The induction cooking system may comprise a plurality of induction cookware, including a first induction cookware and a second induction cookware. Thereby, one induction hob may be used together with a plurality of induction cookware, for example different pieces of induction cookware with respect to type and/or size.

In an embodiment, the induction cookware is an induction cookware according to any of the preceding provisions.

In an embodiment, said induction cooking system is arranged to carry out the method according to any of the above paragraphs.

Any feature described in relation to the induction cookware (and any advantage mentioned in relation thereto) may also be included in the induction cooking system.

### THE DRAWINGS

For a more complete understanding of this disclosure, reference is now made to the following brief description, taken in connection with the accompanying drawings and detailed description, wherein like reference numerals represent like parts. The drawings illustrate embodiment of the invention and elements of different drawings can be combined within the scope of the invention:

FIG. 1 illustrates an induction cooking system according to an embodiment of the invention,

FIGS. 2a-2c illustrate details of an induction cookware according to an embodiment of the invention,

FIGS. 3a-3b illustrate transmission of a power instruction according to embodiments of the present invention,

FIG. 4 illustrate a method according to an embodiment of the invention,

FIG. 5 illustrates the use of a compensation model in a cookware according to an embodiment of the invention,

FIG. 6 illustrates an inside view of a base part of the induction cookware according to an alternative embodiment of the invention,

FIG. 7 illustrates an induction cookware comprising a default operating instruction stored in a digital memory according to an embodiment of the invention,

FIGS. 8a-b illustrate an induction cooking system 1 according to an embodiment of the invention, and

FIG. 9 illustrate an induction cooking system according to another embodiment of the invention.

### DETAILED DESCRIPTION

The present invention is described in view of exemplary embodiments only intended to illustrate the principles and implementation of the present invention. The skilled person will be able to provide several embodiments within the scope of the claims.

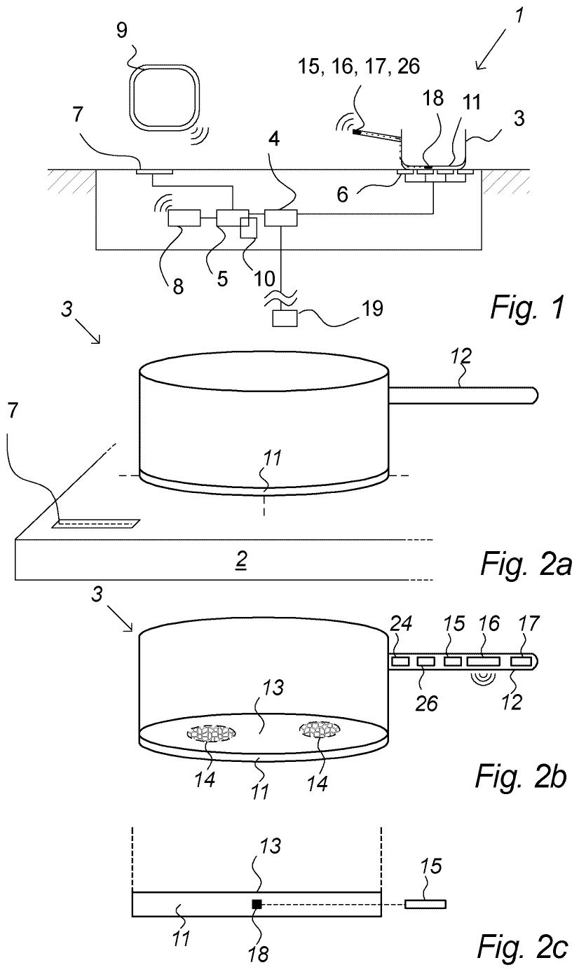

The induction cooking system 1 is illustrated in an embodiment of the invention on FIG. 1. The illustrated cooking system 1 comprises an induction hob 2 (sometimes simply referred to as hob) and an induction cookware 3 (sometimes simply referred to as cookware).

The induction hob 2 comprises a power supply 4 supplying a controller 5 and induction coils 6 from an external electric power source 19. The controller 5 is programmed to control the power to the induction coils 6 and thereby the heating of an induction cookware 3 placed at an area of the hob 1 covered by the induction coils 6 (sometimes referred to as coils). It should be noted that any number of induction coils 6 may be used to supply inductive power to the induction cookware, and the present example is just an illustrative example. For example, an induction cookware 3 may be powered by a single induction coil 6, or a plurality of induction coils 6, such as two or more induction coils.

The hob 2 further comprises a user interface 7 via which the user may communicate with the controller 5 and thereby control the temperature development of heating of food items located inside the cookware 3. The user interface may be integrated in the hob 2 and implemented as a touch panel including a display for illustrating to a user which part of the hob 2 that is controlled and to what heating step of a predetermined number of heating steps that part is controlled.

The hob 2 may further comprise a wireless communication module 8 via which the induction system 1 is able to communicate (in some embodiments bidirectionally) with an external control device 9 (sometimes simply referred to as external device, or referred to as external electronic device) which may be portable such as a tablet, smartphone, smart speaker, cloud service, etc. At least the communication module is arranged in the form of a receiver for receiving data communicated by the cookware and/or the external control device. The wireless communication module 8 may support one or more communication standards such as Wi-Fi, Bluetooth, Infrared, etc. In this way the hob 2 can be controlled and/or configured either locally or from a remote location e.g. via a wireless network.

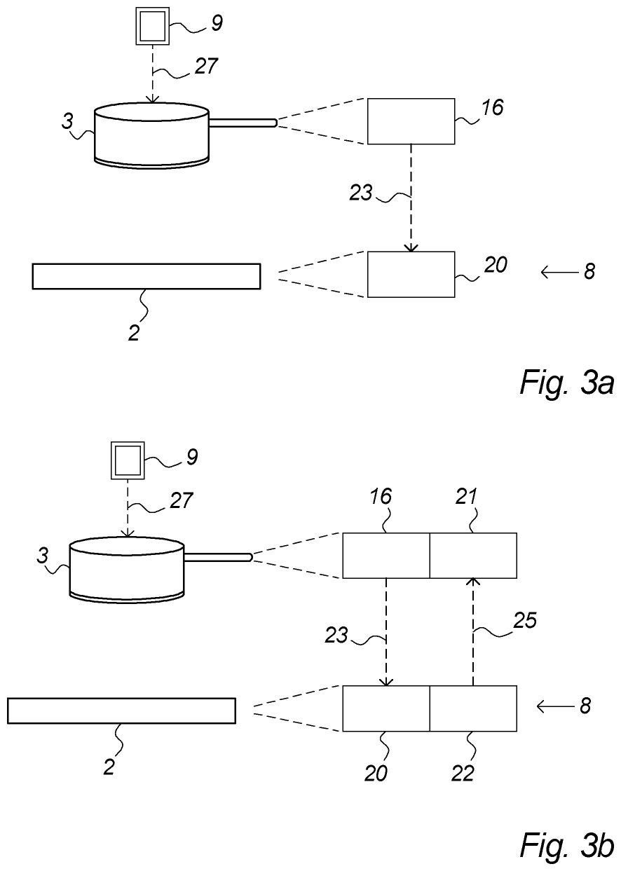

Furthermore, the communication module 8 facilitates wireless data communication with the induction cookware, which is explained in greater details in the embodiments of the invention relating to FIGS. 3a-3b.

The controller 5 may be implemented as any suitable data processor or combination thereof such as a microprocessor or programmable logic controller. The controller 5 may comprise or communicate with a digital memory 10 from where the controller 5 may retrieve operation parameters based on power instructions 23 (see FIGS. 3a-3b in this regard).

As indicated, a hob 2 according to the present invention can be controlled according to a number of predefined heating steps each associated with a predefined power level for heating the cookware 3 positioned above the induction coils 6. In addition, to such traditional heating control, the hob 2 is able to heat a smart cookware 3 and thus perform intelligent/smart heating control.

FIG. 2a-c illustrates the smart cookware 3 of FIG. 1 in further details according to an embodiment of the invention. FIG. 2a illustrates a perspective view of the induction cookware 3, FIG. 2b illustrates an interior view of the induction cookware 3, and FIG. 2c illustrates an inside view of a base part 11 of the induction cookware 3.

The induction cookware 3 as seen in FIG. 2a is an induction cooking pan in the form of a saucepan having a handle 12 but could be any type of cookware. The induction cookware 3 comprises a base part 11 which is the part of the induction cookware 3 that is placed on an induction hob 2 during cooking. As seen in FIG. 2b, the induction cookware 3 comprises a cooking surface 13, which is where the base part 11 comes into contact with food items 14 during cooking. The induction cookware 3 comprises a data processing unit 15, a transmitter 16 and a power supply 17 in the form of a battery, all arranged within the handle 12 of the induction cookware 1.

The cookware further comprises an input 26 which in this embodiment of the invention is a data receiver for receiving data provided by the external control device 9. A user may provide an operating instruction 27 (not shown in the figure) by use of the external control device. For example, the operating instruction may be a specific cooking temperature to be maintained on a cooking surface 13 of the induction cookware. The operating instruction 27 is not limited to this example, and indeed various operating instructions are contemplated in other embodiments of the invention, including temperature profiles and cooking recipes. Although the input 26 is shown as a data receiver, other types of inputs are also contemplated by other embodiments of the invention. For example, the operating instruction may be transmitted from a user interface on the induction hob, or a dedicated user interface on the induction cookware including buttons.

A digital memory 24 is also included in the handle 12 either as a standalone module communicating with the data processing unit 15 or as part of the data processing unit 15. Note that the cookware 3 may also comprise a dedicated compartment for enclosing the data processing unit 15, transmitter 16, digital memory 24 and power supply 17 if not located in the handle.

The induction cookware 3 comprises a temperature sensor 18 (sometimes referred to simply as sensor) which is arranged within the base part 11, as seen in FIG. 2c.

The above-described induction cooking system 1 facilitates a cooking experience unlike any traditional cooking experience. The temperature sensor 18 arranged in the base part 11 of the induction cookware 3 enables the cookware to monitor, at all times, a temperature of the induction cookware. This is used in an advantageous way which ensures that the cookware can be controlled with respect to temperature rather than by the traditional way of cooking where the cookware is heated according to typical discrete heating steps (most induction hobs are configured to provide heating according to preconfigured heating steps 1-9 with most induction hobs also having a preconfigured boost mode typically denoted “P”). By cooking with the induction cooking system 1 according to the above-described embodiment of the invention, much greater control is provided in a cooking process and a user of the system is set much more free as frequent interventions (adjustments) of the heating is not required.

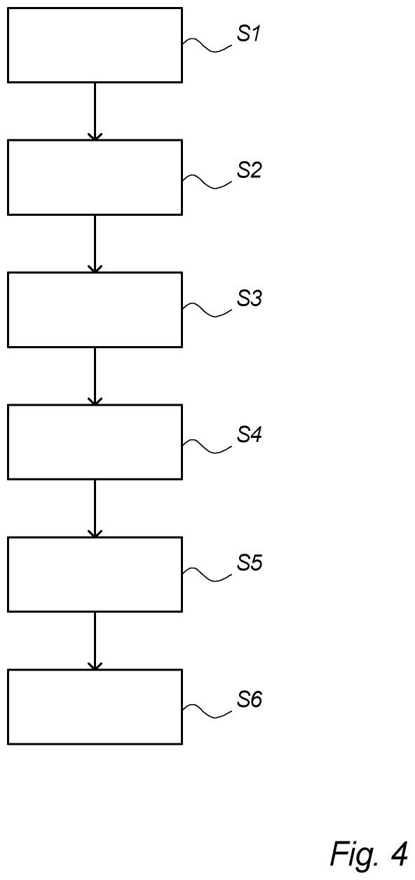

The benefits of the induction cooking system are described in greater detail with respect to the method shown in FIG. 4, which method the induction cooking system 1 is configured to carry out.

FIGS. 3a-3b illustrate the transmission of a power instruction 23 from the induction cookware 3 to the induction hob 2 according to embodiments of the invention.

A crucial aspect of the induction cooking system, and in particular the induction cookware thereof, is that the induction cookware 3 has the initiative in the control of the cooking process. This means that it is the induction cookware 3 which instructs the induction hob 2 to supply a given amount of inductive heating.

FIG. 3a shows one way of instructing the induction hob to supply a certain amount of inductive heating according to an embodiment of the invention. The data processing unit 15 of the induction cookware 3 is configured to generate power instructions 23, which are digital requests targeted at the induction hob 2. The power instruction 23 is generated on the basis of an operating instruction 27 provided by an input of the cookware (see for example input 26 in FIG. 1). Specifically, in this embodiment, the input is a data receiver, and the operating instruction 27 is provided in the cookware 3 by the input receiving the operating instruction 27 from an external control unit 9 in the form of a tablet. Other types of external control units are contemplated according to other embodiments of the invention such as other smart devices including a smartphone, in the same way that the operating instruction 27 may be provided in the input in different ways. A power instruction 23 according to this embodiment of the invention comprises a request for a specific amount of power in units of Watts, however other ways of requesting power are also contemplated according to other embodiments of the invention, including other units of power and other representations of power. The power instructions 23 are transmitted by a transmitter 16 of the induction cookware 3 according to a Bluetooth protocol, however other transmission protocols and ways of transmitting the power instruction are contemplated in other embodiments of the invention. The communication module 8 of the induction hob 2 comprises a receiver 20 which is configured to receive the power instruction 23. Once received by the receiver 20, the power instruction 23 is handled by the controller 5 of the induction hob 2, and the requested power is supplied to the induction cookware 3 as long as this does not give rise to a hazard, e.g., a too high temperature of the induction cooking plate, and for example as long as the requested power does not surpass a user-defined maximum setpoint of the inductive power as selected in a user interface (such as selected in a user interface of the induction hob).

FIG. 3b shows another way of instructing the induction hob to supply a certain amount of inductive heating according to another embodiment of the invention. Similar to the way shown in FIG. 3a, a power instruction 23 is transmitted from a transmitter 16 of the induction cookware 3 to a receiver 20 of the induction hob. However, FIG. 3b differs in that power instructions 23 furthermore comprises a request for the induction hob 2 to return a parameter 25 related to heating of the induction cookware 3. The induction hob 2 is configured to transmit the parameter by use of a transmitter 22 of the induction hob and the induction cookware comprises a receiver 21 configured to receive the returned parameter 25 This parameter is the actual inductive power being supplied to the induction cookware by the induction hob in units of Watts, however, according to other embodiments of the invention, the returned parameter may be expressed in other ways including different units of power, and different representations of power. In another embodiment of the invention, the induction hob 2 is configured to automatically return the parameter without the induction cookware submitting a request for the return of the parameter.

The returned parameter 25 may be seen as an acknowledgement of reception of the power instruction 23. Either it is confirmed that the requested power is complied with by the induction hob, or that less inductive power is being delivered to the induction hob than requested for. For any induction hob there is an upper limit to the amount of inductive power that can be supplied to induction cookware placed thereon. This limit can be reached if the power instruction 23 requests more than this limit, or if other pieces of induction cookware is placed on, and supplied with inductive power, by the induction hob. Another possible reason for delivering less power than what is requested by power instruction 23 is if the user has selected on the induction hob a lower power setting as this setting can be respected as well. The returned parameter 25 is advantageous for the induction cookware to know, as the induction cookware always knows what power is being supplied to it and can always use this for better estimation of the future power needed.

FIG. 4 illustrates steps S1-S6 of a method according to an embodiment of the invention.

In a first step S1, an induction cookware 3 is placed on an induction hob 2. The induction cookware may be an induction cookware as described in any of the previous embodiments, and the induction hob may be an induction hob as described in any of the previous embodiments. Specifically, the induction cookware 3 comprises a temperature sensor arranged in a base part 11 thereof, a power supply 17, an input 26 for providing operating instructions, a data processing unit 15, and a transmitter 16 configured to transmit power instructions to an induction hob.

In a second step S2, an operating instruction 27 is provided by the input 26. The operating instruction may be provided by the input in several ways including being received by the input from an external control device 9 or from the induction hob 2, or the input 26 may be a dedicated input interface on the induction cookware where a user of the cookware can provide the operating instruction 27. In this embodiment of the invention, the operating instruction 27 is a temperature to be maintained at a cooking surface 13 of the induction cookware 3.

In a third step S3, a power instruction 23 is provided by the data processing unit 15 on the basis of the provided operating instruction 27. The data processing unit 15 is configured to perform a calculation based on the operating instruction 27 and thermal properties of the induction cookware, such that the inductive power, to be supplied by the induction hob which achieves the conditions prescribed by the operating instruction, is established. Specifically, in this embodiment, the data processing unit 15 calculates the required inductive power in units of Watts to be supplied to the induction cookware 3 by the induction hob 2 in order to reach the prescribed temperature of the cooking surface 13 of the cookware as prescribed in the operating instruction 27. As seen in various embodiments of the invention, this calculation may employ the use of a compensation model which is described later in the following.

In a fourth step S4, the power instruction 23 requesting a specific inductive power in units of Watts, is transmitted by the induction cookware 3 to the induction hob 2. The transmission may occur using e.g., Bluetooth as described in relation to FIG. 3.a, but other ways of transmitting the power instruction to the induction hob are contemplated according to other embodiments of the invention. That is, the power instruction is transmitted by a transmitter 16 of the induction cookware 3.

In a fifth step S5, the power instruction 23 is received in the induction hob 2. In this embodiment of the invention, the power instruction is received in a data receiver 20 of the induction hob 2.

In a sixth step S6, the induction hob 2 provides inductive heating to the induction cookware 3 on the basis of the power instruction 23. For example, the power instruction may specify that the induction cookware should receive 2400 Watts of inductive power. The Induction hob 2 may provide the 2400 Watts of power if such power is available to the induction hob, or specifically available to the cooking zone of the induction hob on which the induction cookware is positioned. If however, the requested power is not available, the induction hob may supply the maximally available inductive power to the induction cookware which may be less than 2400 Watts, for example 1800 Watts. If less power is delivered to the induction cookware than requested by the power instruction, the induction hob preferably informs the induction cookware of the ‘reduced’ amount of power supplied, such as in the way described with relation to FIG. 3b.

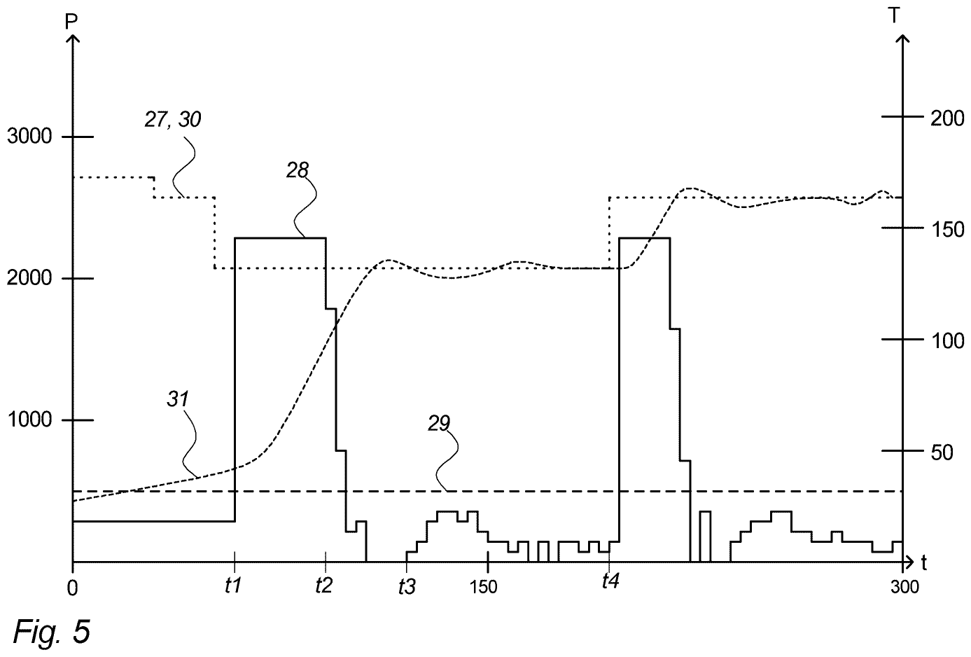

In an embodiment of the invention, the digital memory 24 of the induction cookware 3 comprises a compensation model (not shown). The compensation model is a digitally implemented physical and/or mathematical model representative of the induction cookware 3. The compensation model relates to physical characteristics of the induction cookware including physical layout and composition of the cookware. The compensation model further relates to thermal properties of the induction cookware including heat capacity of the cookware and heat losses to the surroundings of the cookware. A key concept of the compensation model is its ability to estimate an actual temperature of the induction cookware at a point of interest which in this case is a cooking surface 13 of the induction cookware. The data processing unit 15 is arranged to provide the power instruction on the basis of both temperature readings provided by the temperature sensor 18, the compensation model and the operating instructions provided by the input of the induction cookware. The compensation model according to this embodiment of the invention is further a time and heating dependent compensation model which is arranged such that the power instructions provided on the basis of the model factors in latency of the temperature readings provided by the sensor 18. This latency is made clear in FIG. 5.

FIG. 5 shows a graphical representation of an actual cooking process performed by an induction cooking system 1 according to an embodiment of the invention. The graphical representation shows a graph on which the horizontal axis depicts time (t). As is seen, the graph depicts a cooking process occurring in a time range from 0 seconds to 300 seconds, i.e., over a time duration of 5 minutes. The vertical axis depicts both power (P) in units of Watts and temperature (T) in units of degrees Celsius. The solid curve 28 depicts the inductive power supplied by the induction hob to the induction cookware, the dashed curve 29 depicts the average inductive power supplied by the induction hob to the induction cookware, the dotted curve 27, 30 depicts the temperature requested by an operating instruction 27, and the dashed curve 31 depicts the estimated temperature of the cooking surface 13 of the induction cookware 3.

As seen in the figure, prior to the big burst of power being supplied at time t1, the requested temperature is changed two times, starting from around 170 degrees Celsius to about 135 degrees Celsius. This is likely due to a user of the induction cooking system adjusting the desired temperature of the induction cookware in two steps from an original temperature setting. For example, the user may have adjusted the desired temperature using an external control device 9, such as a tablet. Another possibility is an automated cooking process changing the temperature according to a cooking recipe.

As seen, prior to time t1, a small amount of power is provided, but suddenly at t1, a large amount of power is supplied to the cookware, and the temperature depicted by curve 31 increases at a greater rate, i.e. the derivative of temperature with respect to time is increased. It is noted that points along the temperature curve are estimated by the data processing unit 15 on the basis of temperature measurements by the sensor 18 and the compensation model since the temperature sensor 18 is placed below the cooking surface 13 of the cookware and embedded in the cookware. Thus, the compensation model may take into account the effects of the displacement of the sensor with respect to the point of interest (i.e. the cooking surface). An interesting point is observed around time t2. As the temperature curve 31 rises towards the requested temperature 30 the power 28 is reduced, and for a brief moment completely turned off until power is re-supplied at time t3. This is a great example of the temperature latency of the sensor and system, which latency the compensation model is arranged to take into account. Because the compensation model can project temperature developments given current power supply and temperature, it is capable of determining when power should be dialed down. In this sense, at about time t2, the cookware provides a power instruction using the compensation model, which power instruction requests the induction hob to reduce power. As seen at about time t3 the estimated temperature of the cooking surface 13 is more or less similar to the requested temperature 30 until time t4 where the user requests a higher temperature. At this point a new operating instruction is provided by the input of the cookware, and in accordance therewith, a corresponding power instruction is transmitted to the induction hob and power is increased. As seen again, due to the compensation model, the power is cut back before the estimated temperature 31 reaches the requested temperature 30.

A further detail is shown in FIG. 5 in the beginning of the graph at time t=0, before the user requested a new temperature. The digital memory 24 of the induction cookware comprises a default operating instruction. This default operating instruction may be the previously used operating instruction prior to the cookware going into a power saving mode and which is automatically used upon start-up of the cookware, or it may be a default operating instruction selected by the user among a plurality of pre-programmed operating instructions. Once turning-on the cookware, the default operating instruction is used in the cooking system until a new setting is applied by the user.

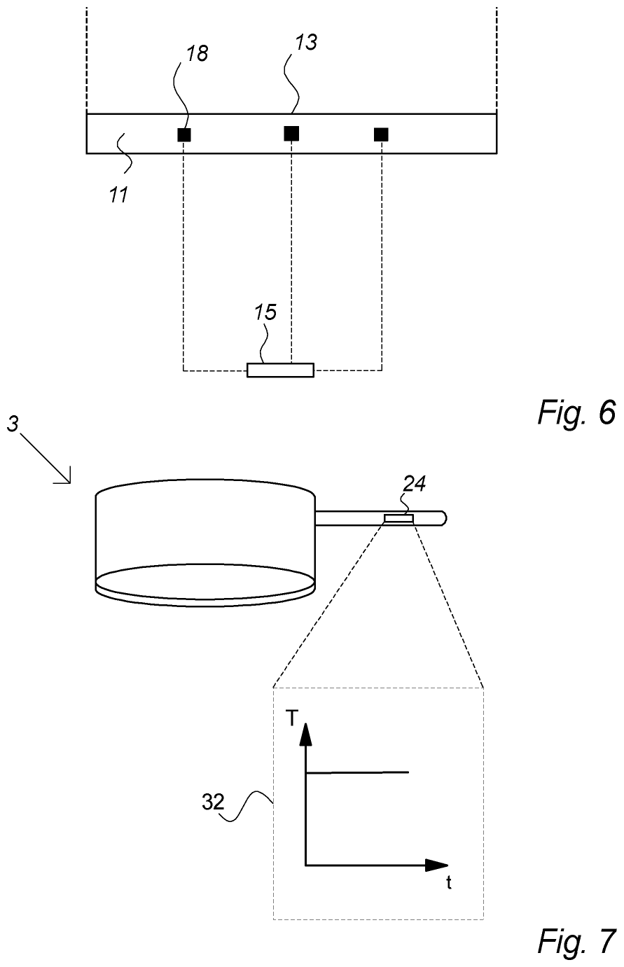

FIG. 6 illustrates an inside view of a base part 11 of the induction cookware 3 according to an alternative embodiment of the invention. As seen, FIG. 6 closely resembles FIG. 2c, however, the induction cookware of this embodiment comprises a plurality of temperature sensors 18, specifically three temperature sensors 18. As seen in the figure, the three temperature sensors are communicatively coupled to the data processing unit 15 of the cookware 3. The data processing unit 15 is merely depicted for the purpose of illustrating that a data communication exists between the sensors and the data processing unit, and the figure is not representative of actual placement of the data processing unit in the induction cookware. The actual placement of the data processing unit 15 in the induction cookware 3 is as seen in FIG. 2b where the data processing unit 15 is located in a handle 12 of the cookware.

The cookware 3 comprising a plurality of temperature sensors may function in exactly the same way as the previous disclosure of a cookware, however, the plurality of temperature sensors may further improve temperature readings of the base part 11 of the induction cookware compared with the use of a single temperature sensor. In the present embodiment, the plurality of temperature sensors 18 are placed in the base part 11 of the cookware, however other distributions of temperature sensors are conceivable according to other embodiments. For example, one or more sensors may additionally be placed on a side of the induction cookware, so that one or more temperature sensors are placed in the base part, and one or more temperature sensors are placed in/on a side of the induction cookware.

FIG. 7 illustrates an induction cookware 3 according to an embodiment of the invention. The induction cookware 3 is seen comprising a digital memory 24, however, the cookware 3 also comprises the components seen in FIGS. 2b and 2c. These components include one or more temperature sensors 18, a data processing unit 15, a transmitter 16, and a power supply 17. These additional components are not shown in the figure in order to keep a focus on the digital memory 24. The digital memory 24 is storing a default operating instruction 32 which in this embodiment is a fixed temperature to be applied to the induction cookware until a user terminates the cooking process. The storing of a default operating instruction 32 in the digital memory 24 of the induction cookware 3 has the effect that when a user of the cookware places the cookware on an induction hob 2 of an induction cooking system 1 according to the previously disclosed provisions, the induction hob will automatically apply inductive power according to the default operating instruction 32. In this way a cookware 3 may function as a “mono-tasker” in that the cookware is by default arranged to operate according to the same preset cooking setting. This is particularly useful in large industrial kitchens where multiple repetitions of cooking processes occur and specific cookware are destined for specific processes. In such situations, the default operating instruction 32 facilitates a quick initiation of the cooking process as no manual assignment of cooking settings may be required.

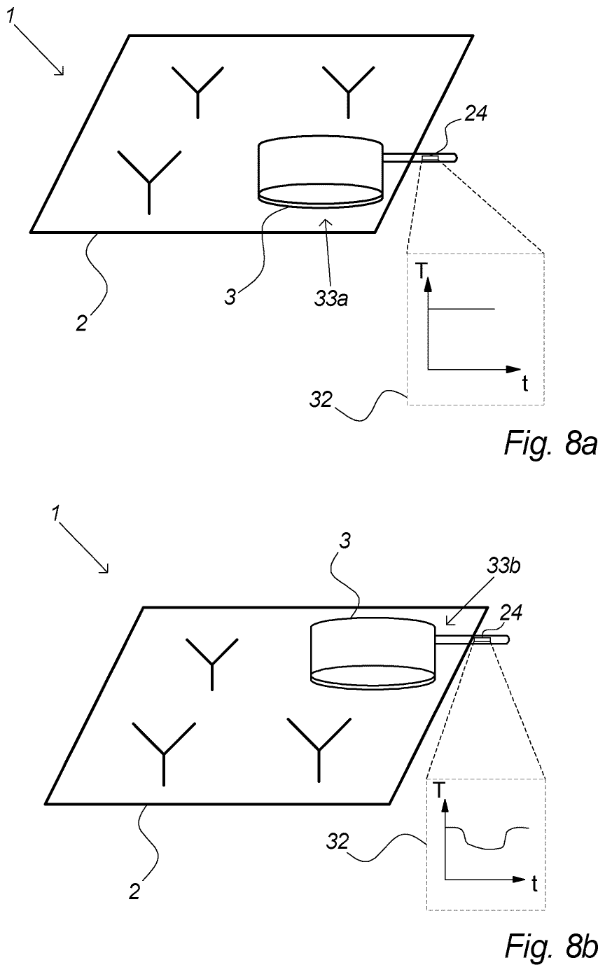

FIGS. 8a and 8b illustrate an induction cooking system 1 according to an embodiment of the invention. The system 1 as seen in FIG. 8a comprises an induction hob 2 having a plurality of cooking zones (see “Y”-letter shaped markings in FIG. 8a) including a first cooking zone 33a. As seen in the figure, an induction cookware 3 is positioned on the first cooking zone 33a, and inductive power can be applied to the induction cookware 3 by one or more induction coils associated with the first cooking zone. The induction cookware 3 is an induction cookware as illustrated in FIG. 7. A default operating instruction 32 is stored in the digital memory 24 of the induction cookware 3. However, the default operating instruction 32 is different from the one illustrated in FIG. 7 in that the default operating instruction 32 of FIG. 8a is cooking zone specific. This means that the content of the operating instruction (cooking temperature, cooking recipe, inductive power, inductive power density among others) is directed at the use of the cookware on a specific cooking zone. This is better illustrated by looking at FIG. 8b which illustrates the same induction cooking system 1. As seen in FIG. 8b, the induction cookware 3 is positioned in a second cooking zone 33b of the induction hob, and the default operating instruction 32 seen in the figure is different from the default operating instruction seen in FIG. 8a. In FIG. 8a, the default operating instruction 32 is a constant cooking temperature (cooking temperature T is constant throughout time t), whereas in FIG. 8b the default operating instruction is a time-varying cooking temperature (cooking temperature T varies over time t). The induction cookware 3 of this embodiment comprises a sensor for detecting the alternating magnetic field produced by the underlying cooking zone, and measured signals detected by that sensor (dedicated wire loop sensor, wire loop of another sensor, e.g., a wire loop used for wiring a temperature sensor, or any other sensor unit capable of measuring induced current) can be compared with the driving signals of the one or more induction coils generating inductive power. Therefrom the induction cooking system can deduce on which cooking zone the induction cookware is placed, and thereby the induction cookware 3 knows which default operating instruction 32 applies.

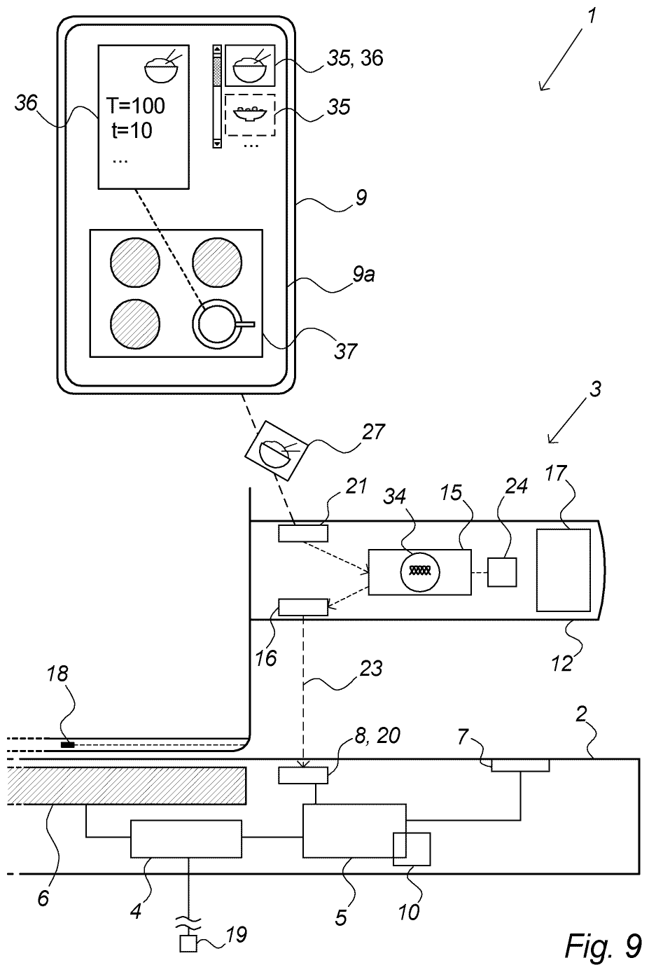

FIG. 9 illustrates an induction cooking system 1 according to an embodiment of the invention. The induction cooking system comprises an induction hob 2, an induction cookware 3 in the form of a saucepan (note that only a part of the full saucepan is shown in the figure), and an external control device. The external control device 9 is a tablet comprising a screen displaying a graphical user interface 9a to a user of the system, however according to other embodiments, the external control device may be a smartphone, a laptop, or any other kind of electronic device capable of displaying a graphical user interface. The graphical user interface 9a shows a top-down view representation of the induction hob 2 of the induction cooking system 1. In the present embodiment, the induction hob comprises four cooking zones, however according to other embodiments, the induction hob may comprise any other number of cooking zones, such as three or five cooking zones. As seen in the induction hob representation 37, the induction cookware 3 is positioned on one of the cooking zones of the induction hob 2. The graphical user interface 9a facilitates the user of the system to select a recipe 35 to be made among a list of multiple recipes 35. In the present screen view two recipes 35 are seen; a rice cooking recipe and a meatball curry recipe. By scrolling through the list the user may select among other recipes of the system. In the present embodiment, the user has selected the rice cooking recipe and this is illustrated to the left in the graphical user interface 9a as a selected recipe 36 along with parameters of the recipe, for example temperatures and time durations of the recipe. The selected recipe 36 denotes a temperature of 100 degrees Celsius for a time duration of 10 minutes, however this is only exemplary of a recipe, and other recipes may exist having different temperatures and time intervals, for example including multiple time intervals with different respective cooking temperatures. The user selected recipe 36 is transmitted wirelessly by the external control device 9 to the receiver 21 of the induction cookware 3 using a Bluetooth protocol. According to other embodiments, other wireless data communication protocols may be used. The selected recipe 36 is transmitted to the induction cookware 3 as an operating instruction 27.

In the induction cookware, the transmitted operating instruction 27 is processed by the data processing unit 15. The data processing unit 15 is operationally associated with a digital memory 24 storing thereon a compensation model of the induction cookware 3 relating to physical characteristics of the cookware. The data processing unit 15 executes a power control function 34 which is a function that takes as input an operating instruction 27 and converts this to a power instruction for the induction hob 2. That is, by considering the chosen recipe 36 through the operating instruction 27, and taking into account conditions of the cookware including the compensation model and sensor input provided by the temperature sensor 18, the power control function 34 may at any time be capable of determining an amount of power (or power density) to be provided to the cookware 3 by the induction hob 2 in order to execute the selected recipe 36. In the present embodiment, the power control function 34 is implemented using a proportional-integral-derivative PID control algorithm, however the power control function may be implemented using other control algorithms according to other embodiments. It should be noted that the control scheme shown in FIG. 9 is in the context of operating instructions 27 in the form of recipes, however, it should be noted, that according to other embodiments the operational instruction may also be a user-selected temperature to be maintained in the induction cookware 3. Once outputted by the power control function 34, a power instruction 23 is transmitted wirelessly to the receiver 20 of the wireless communication module 8 of the induction hob 2. This data transmission is performed using Bluetooth, however, other wireless data communication protocols may also be used instead according to other embodiments. The controller 5 along with power supply 4 and one or more induction coils 6 ensure that the requested power (or power density) as defined in the power instruction 23 is transmitted to the induction cookware 3. As also seen in the figure, the induction cookware 3 comprises a power supply 17 in the form of a battery which, along with various other components of the induction cookware 3 is installed inside a handle 12 of the induction cookware. Various other components of the induction hob 2 are also shown in FIG. 9, and these components are also seen in FIG. 1.

An important consideration regarding the present embodiment is that the power control function 34 is exclusively implemented in the induction cookware, and that the operating instruction 27 is provided using an external control device 9. Such a distribution of the technical features, i.e., the selection of a recipe occurring in an external device and the execution of the recipe occurring in the cookware is particularly advantageous since the cookware does not need to have any physical buttons or input interface such a s screen for a user to select cooking recipes. Thereby, the induction cookware may conserve battery more easily, and the induction cookware may more easily be cleaned as there is no need of water-sensible components such as screens and buttons. Moreover, this specific distribution of technical features ensures that the execution of the selected recipe 36 may occur even in the absence of the external control device, for example if the battery runs out of the device, or if a user moves the device out of communication reach of the cookware.

It should be noted that although FIG. 9 depicts the operating instruction 27 as a cooking recipe, the operating instruction may alternatively be any other kind of digital instruction defining a target cooking condition in the induction cookware, such as a cooking temperature.

### LIST OF REFERENCE SIGNS

1 Induction cooking system
2 Induction hob
3 Induction cookware
4 Power supply
5 Controller
6 Induction coils
7 User interface
8 Wireless communication module
9 External control device
9a Graphical user interface
10 Digital memory of induction hob
11 Base part of induction cookware
12 Handle of induction cookware
13 Cooking surface of induction cookware
14 Food item
15 Data processing unit of induction cookware
16 Transmitter of induction cookware
17 Power supply of induction cookware
18 Temperature sensor of induction cookware
19 External electric power source
20 Receiver of induction hob
21 Receiver of induction cookware
22 Transmitter of induction hob
23 Power instruction
24 Digital memory of induction cookware
25 Returned parameter
26 Input
27 Operating instruction
28 Inductive power
29 Average power
30 Requested temperature
31 Estimated temperature
32 Default operating instruction
33a First cooking zone
33b Second cooking zone
34 Power control function
35 Recipe
36 Selected recipe
37 Induction hob representation
S1-S6 Method steps

1. An induction cookware comprising:
a base part for placing on an induction hob;
one or more temperature sensors arranged in the base part;
a power supply;
an input for providing operating instructions;
a data processing unit configured to provide power instructions based on the operating instructions provided by the input; and
a transmitter configured to transmit the power instructions to the induction hob.

2. (canceled)

3. The induction cookware according to claim 1, wherein the induction cookware does not comprise a user interface.

4. The induction cookware according to claim 1, wherein the data processing unit implements a power control function which is exclusively implemented by the data processing unit.

5. (canceled)

6. The induction cookware according to claim 1, wherein the induction cookware comprises a memory comprising a compensation model arranged to estimate an actual temperature of the induction cookware based on one or more temperature measurements provided by the one or more temperature sensors.

7-8. (canceled)

9. The induction cookware according to claim 6, wherein the compensation model is heating and/or time dependent.

10. (canceled)

11. The induction cookware according to claim 6, wherein the compensation model is arranged to estimate a change of temperature of the induction cookware based on energy supplied to the induction cookware through induction.

12. (canceled)

13. The induction cookware according to claim 1, wherein the operating instructions comprise recipes.

14. The induction cookware according to claim 1, wherein the operating instructions defines one or more temperature setpoints and/or one or more power setpoint.

15-17. (canceled)

18. The induction cookware according to claim 1, wherein the induction cookware comprises a memory comprising a default operating instruction.

19. The induction cookware according to claim 18, wherein the default operating instruction is exchangeable.

20. The induction cookware according to claim 18, wherein the default operating instruction is cooking zone specific.

21-39. (canceled)

40. A method of heating an induction cookware, the method comprising:
placing an induction cookware on an induction hob, the induction cookware comprising a base part for placing on the induction hob, one or more temperature sensors arranged in the base part, a power supply, an input for providing operating instructions, a data processing unit, and a transmitter configured to transmit power instructions to the induction hob;
providing operating instructions by the input:
providing, by the data processing unit, a power instruction based on the operating instructions;
transmitting, by the induction cookware, the power instruction to the induction hob;
receiving the power instruction at the induction hob; and
providing inductive heating to the induction cookware, by the induction hob, based on the power instruction.

41. The method according to claim 40, wherein the power instruction is further provided based on one or more temperature measurements provided by the one or more temperature sensors.

42. The method according to claim 40, wherein providing the power instruction comprises providing the power instruction based on a compensation model.

43-44. (canceled)

45. The method according to claim 40, wherein the input of the induction cookware comprises a data receiver configured to receive operating instructions transmitted by an external electronic device, and wherein providing the operating instructions by the input comprises:
providing an operating instruction, by a user, using an input interface of an external electronic device;
transmitting the operating instruction using a transmitter of the external electronic device; and
receiving the operating instruction using the data receiver.

46. The method according to claim 40, wherein the data processing unit executes a power control function which is arranged in the induction cookware.

47. The method according to claim 40, wherein the operating instructions comprises a recipe.

48. (canceled)

49. An induction cooking system comprising:
an induction hob comprising a receiver for receiving power instructions; and
an induction cookware comprising:
a base part for placing on the induction hob;
one or more temperature sensors arranged in the base part;
a power supply;
an input for providing operating instructions;
a data processing unit configured for providing power instructions based on operating instructions provided by the input; and
a transmitter configured to transmit the power instructions to the receiver of the induction hob,
wherein the induction hob is configured to apply inductive power to the induction cookware based on power instructions received by the receiver.

50. The induction cooking system according to claim 49, wherein the induction cooking system is configured for two-way communication between the induction cookware and the induction hob.

51. (canceled)

52. The induction cooking system according to claim 49, wherein the induction cooking system further comprises an external electronic device, wherein the input comprises a data receiver, and wherein the external electronic device and the data receiver are configured for transmission of operating instructions from the external electronic device to the data receiver.

53-60. (canceled)
